(19) United States
(12) Patent Application Publication
(10) Pub. No.: US 2026/0269364 A1
(43) Pub. Date: Sep. 10, 2026

(54) MULTI-SECTION POLYMER FLUID CONDUIT ARRANGEMENTS FOR TRACTION BATTERY PACK

(71) Applicant: Ford Global Technologies, LLC, Dearborn, MI (US)

(72) Inventors: Antony George Schepak, Howell, MI (US); Deanna Marie Winton Hoffman, Ann Arbor, MI (US); Mohammadreza Eftekhari, Novi, MI (US); Patrick Daniel Maguire, Ann Arbor, MI (US); Daniel Benjamin Kok, Ann Arbor, MI (US); Yi Zhang, Ann Arbor, MI (US); Dennis Manning, Novi, MI (US)

(21) Appl. No.: 19/294,466

(22) Filed: Aug. 8, 2025

Related U.S. Application Data
(60) Provisional application No. 63/766,671, filed on Mar. 4, 2025.

(51) Int. Cl. H01M 10/6557; H01M 10/613; H01M 10/625; H01M 10/643; H01M 10/6568; H01M 50/213; H01M 50/249; B60L 50/64

(52) U.S. Cl. CPC H01M 10/6557; H01M 10/613; H01M 10/625; H01M 10/643; H01M 10/6568; H01M 50/213; H01M 50/249; B60L 50/64; H01M 2220/20

(57) ABSTRACT

A traction battery pack may include a plurality of battery cells. The traction battery pack may include a fluid conduit arranged adjacent the battery cells. The fluid conduit may define a passageway configured to guide thermal exchange fluid relative to the battery cells. The fluid conduit may includes a first conduit section and a second conduit section. The first and second conduit sections may be made of polymer.

### RELATED APPLICATIONS

This application claims the benefit of U.S. Provisional Application No. 63/766,671, filed Mar. 4, 2025, the entirety of which is herein incorporated by reference.

### TECHNICAL FIELD

This disclosure relates generally to a polymer fluid conduit of a traction battery pack of an electrified vehicle, and in particular to a polymer fluid conduit having a first conduit section and a second conduit section.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a traction battery pack, including: a plurality of battery cells; and a fluid conduit arranged adjacent the battery cells, wherein the fluid conduit defines a passageway configured to guide thermal exchange fluid relative to the battery cells, wherein the fluid conduit includes a first conduit section and a second conduit section, and wherein the first and second conduit sections are made of polymer.

In some aspects, the techniques described herein relate to a traction battery pack, wherein: the fluid conduit section extends between a first end and a second end, and the first and second conduit sections each extend from the first end to the second end.

In some aspects, the techniques described herein relate to a traction battery pack, wherein the first and second conduit sections are formed separately from one another.

In some aspects, the techniques described herein relate to a traction battery pack, further including: a first sealed connection between the first and second conduit sections, and a second sealed connection between the first and second conduit sections.

In some aspects, the techniques described herein relate to a traction battery pack, wherein the first and second sealed connections are configured such that the first and second conduit sections fluidly bound a perimeter of the passageway.

In some aspects, the techniques described herein relate to a traction battery pack, wherein the first and second sealed connections are provided by one or both of welding and adhesive.

In some aspects, the techniques described herein relate to a traction battery pack, wherein: the first sealed connection is provided between a first projection and a first flat section, and the second sealed connection is provided between a second projection and a second flat section.

In some aspects, the techniques described herein relate to a traction battery pack, wherein: the first sealed connection is provided between a first projection and a second projection, the first and second projections overlap one another, the second sealed connection is provided between a third projection and a fourth projection, and the third and fourth projections overlap one another.

In some aspects, the techniques described herein relate to a traction battery pack, wherein: the first and second projections vertically overlap one another, and the third and fourth projections vertically overlap one another.

In some aspects, the techniques described herein relate to a traction battery pack, wherein: the first and second projections horizontally overlap one another, and the third and fourth projections horizontally overlap one another.

In some aspects, the techniques described herein relate to a traction battery pack, wherein: the first conduit section and the second conduit section each partially define a first groove, the first conduit section and the second conduit section each partially define a second groove, a first insert is arranged in the first groove, a second insert is arranged in the second groove, and the first sealed connection is established by a welding process that fuses the first conduit section, the second conduit section, and the first insert, and the second sealed connection is established by a welding process that fuses the first conduit section, the second conduit section, and the second insert.

In some aspects, the techniques described herein relate to a traction battery pack, further including: a top wall, a bottom wall, wherein a perimeter of the passageway is bound by the top wall, the first conduit section, the second conduit section, and the bottom wall.

In some aspects, the techniques described herein relate to a traction battery pack, further including: a first sealed connection between the first conduit section and the top wall, a second sealed connection between the first conduit section and the bottom wall, a third sealed connection between the second conduit section and the top wall, and a fourth sealed connection between the second conduit section and bottom wall.

In some aspects, the techniques described herein relate to a traction battery pack, wherein: the plurality of battery cells includes a first group of battery cells and a second group of battery cells, and the fluid conduit is arranged between the first and second groups of battery cells.

In some aspects, the techniques described herein relate to a traction battery pack, wherein: a first side of the first conduit section faces the first group of battery cells, and a second side of the first conduit section faces the second conduit section and partially defines the passageway, and a first side of the second conduit section faces the first conduit section and partially defines the passageway, and a second side of the second conduit section faces the second group of battery cells.

In some aspects, the techniques described herein relate to a traction battery pack, wherein: the first side of the first conduit section directly contacts the first group of battery cells, and the second side of the second conduit section directly contacts the second group of battery cells.

In some aspects, the techniques described herein relate to a traction battery pack, wherein: the first side of the first conduit section contacts the first group of battery cells via a layer of thermal interface material, and the second side of the second conduit section contacts the second group of battery cells via a layer of thermal interface material.

In some aspects, the techniques described herein relate to a traction battery pack, further including: a manifold assembly configured to direct thermal exchange fluid to the passageway.

In some aspects, the techniques described herein relate to a traction battery pack, wherein the plurality of battery cells are cylindrical battery cells.

In some aspects, the techniques described herein relate to a method, including: injection molding a first conduit section of a fluid conduit, wherein the fluid conduit is configured to define a passageway for thermal exchange fluid to flow within a traction battery pack; injection molding a second conduit section of the fluid conduit; and joining the first conduit section and the second conduit section so as to establish a fluid-tight seal between the first conduit section and the second conduit section.

### BRIEF DESCRIPTION OF THE DRAWINGS

FIG. 1 schematically illustrates an electrified vehicle.

FIG. 2 illustrates a plurality of cylindrical battery cells relative to an electrified vehicle.

FIG. 3 is an expanded view of a traction battery pack.

FIG. 4 is a perspective view of the traction battery pack of FIG. 3, with a top wall of the traction battery pack removed.

FIG. 5 illustrates an arrangement of battery cells and fluid conduits within the traction battery pack.

FIG. 6 illustrates an example fluid conduit.

FIG. 7A is a close-up view of a top portion of the fluid conduit, and illustrates a first example interface between the first and second conduit sections.

FIG. 7B is a close-up view of a bottom portion of the fluid conduit, and illustrates the first example interface.

FIG. 8 somewhat schematically illustrates the fluid conduit with a second example interface.

FIG. 9A illustrates the fluid conduit with a third example interface.

FIG. 9B illustrates an insert relative to the first and second conduit sections.

FIG. 10 somewhat schematically illustrates an alternative configuration of the first and second conduit sections.

FIG. 11 illustrates an arrangement of the bottom wall.

FIG. 12 is a top view of a portion of the fluid conduit.

FIG. 13 illustrates another alternative configuration of the first and second conduit sections.

FIG. 14 illustrates an alternative fluid conduit arrangement.

### DETAILED DESCRIPTION

This disclosure relates generally to a polymer fluid conduit of a traction battery pack of an electrified vehicle, and in particular to a polymer fluid conduit having a first conduit section and a second conduit section. Among other benefits, which will be appreciated from the description below, this disclosure facilitates routing of thermal exchange fluid relative to cylindrical battery cells, while fluidly isolating the thermal exchange fluid from the cells. The fluid conduit of this disclosure is relatively easily formed using known manufacturing techniques, such as injection molding, and in a manner that provides the fluid conduit with minimal to no draft angle in locations where the fluid conduit is adjacent a battery cell, thereby permitting the fluid conduit to closely conform to the shape of the battery cell. These and other benefits will be appreciated from the below.

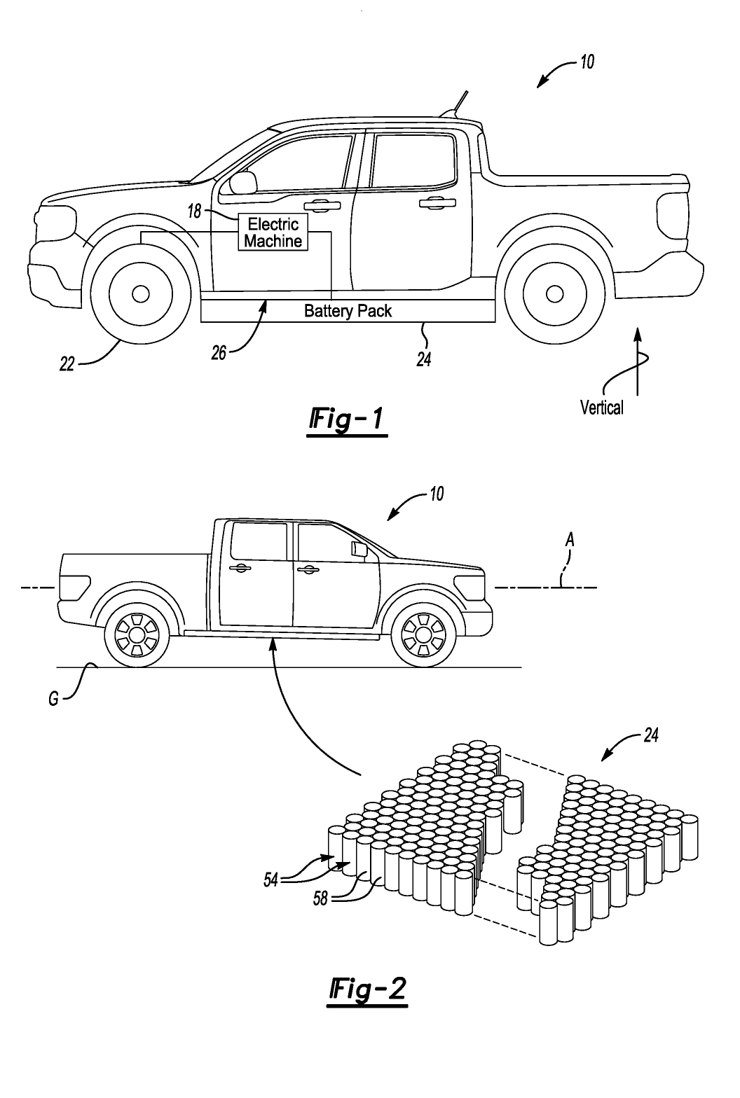

With reference to FIG. 1, an electrified vehicle 10 includes a battery pack 24, an electric machine 18, and wheels 22. The battery pack 24 powers the electric machine 18, which can convert electrical power to mechanical power to drive the wheels 22. The battery pack 24 is thus a traction battery pack.

The battery pack 24 is, in the exemplary embodiment, secured to an underbody 26 of the electrified vehicle 10. The battery pack 24 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

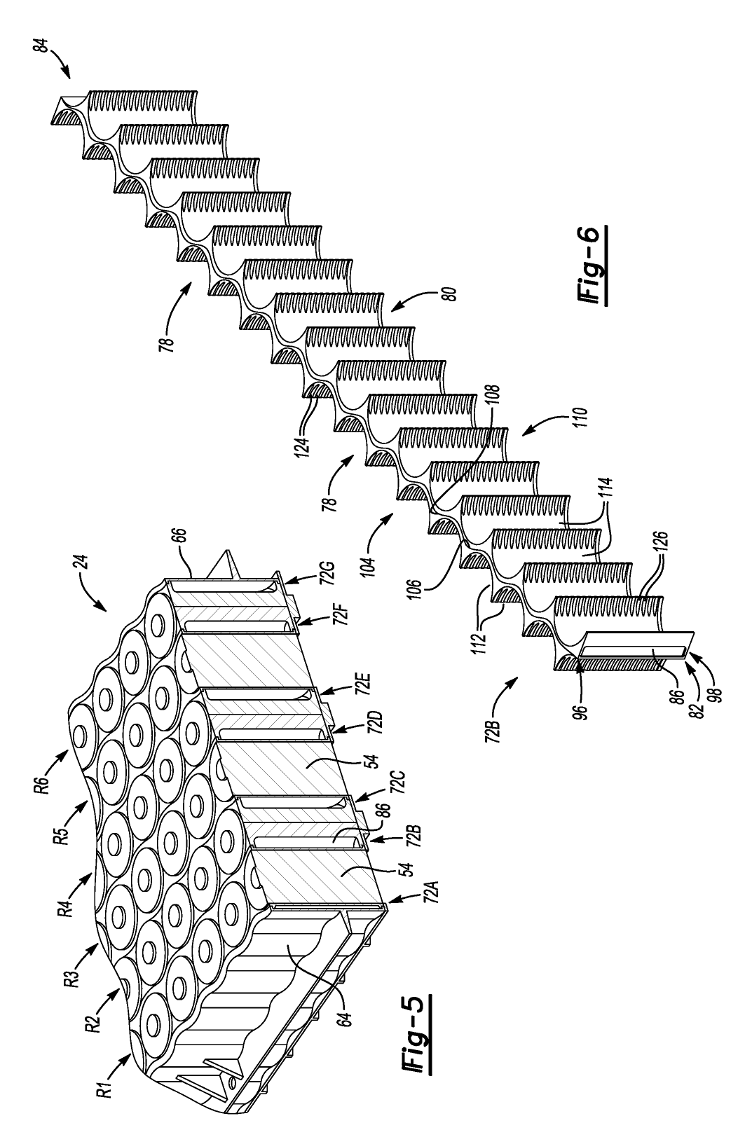

With reference to FIGS. 2-5, the battery pack 24 includes a plurality of individual battery cells 54. The battery cells 54 each include an outer case 58. The outer cases 58 can be a metal or metal alloy. The outer cases 58 are cylindrical, or substantially cylindrical, in this example. The battery cells 54 may be referred to as cylindrical battery cells. The battery cells 54 include terminals configured to electrically couple to other battery cells 54 and/or busbars, as examples, adjacent a common side thereof, which in this example is a top side.

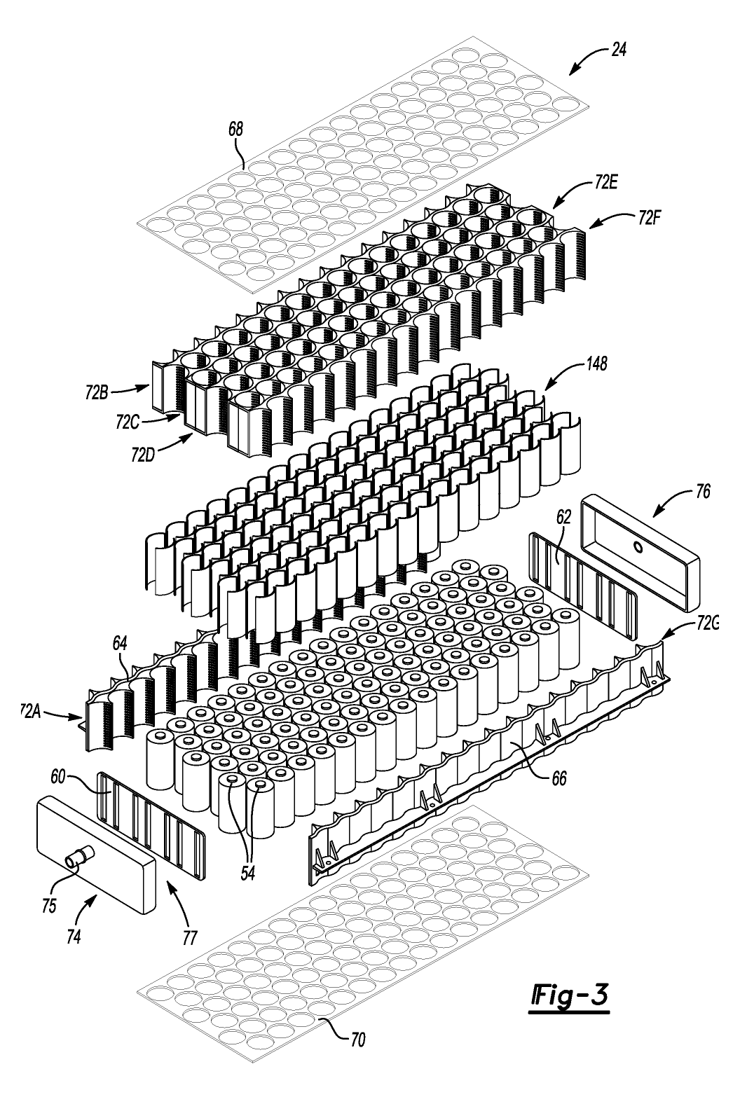

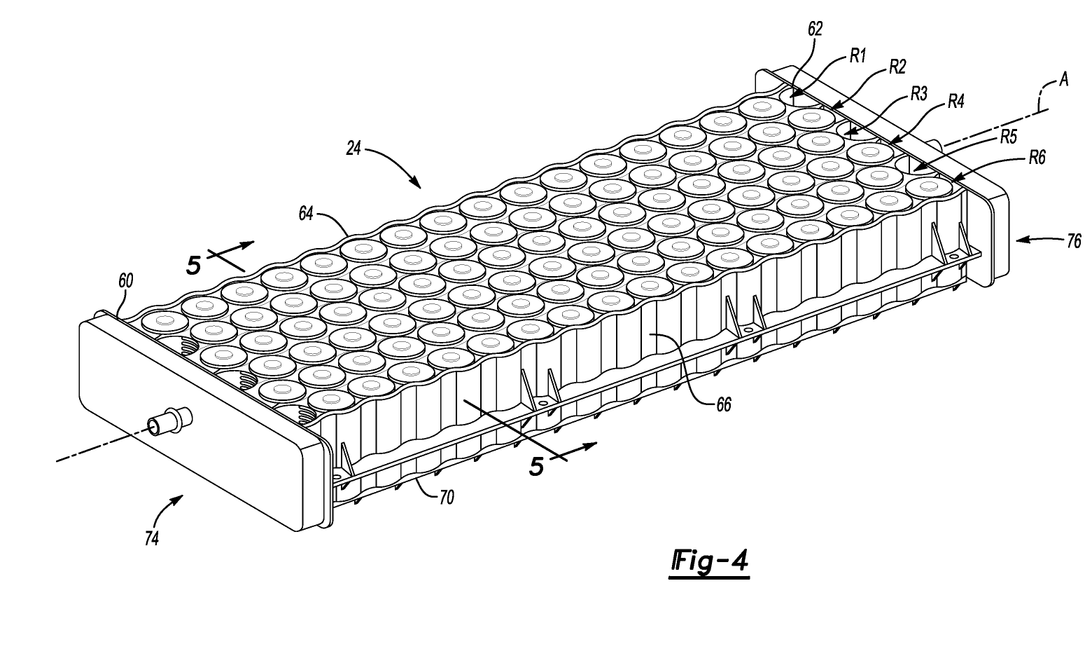

With specific reference to FIGS. 3 and 4, the battery pack 24 includes a first end wall 60, a second end wall 62 arranged on an opposite side of the battery pack 24 as the first end wall 60, a first side wall 64 extending along a first side of the battery pack 24 between the first and second end walls 60, 62, and a second side wall 66 extending between the first and second end walls 60, 62 along a second side of the battery pack 24 opposite the first side wall 64. The battery pack 24 further includes a top wall 68 and a bottom wall 70. The top wall 68 is removed in FIG. 4 for ease of viewing the arrangement of battery cells 54.

As shown in FIG. 4, the battery cells 54 are arranged in groups, which here are rows R1-R6. Rows R1-R6 extend generally from first end wall 60 to second end wall 62. While there are six rows R1-R6 in this example, this disclosure extends to battery packs with a different number of rows. Further, this disclosure is not limited to the particular number battery cells 54 in a particular row.

Rows R1-R6 are each generally parallel to one another and, optionally, to a longitudinal axis A of the vehicle 56, in this example. Adjacent rows R1-R6 are staggered relative to one another to enable closer packaging of the battery cells 54, which results in the battery cells 54 having a generally honeycomb pattern. In this example, the battery cells 54 are arranged such that the electrical connections between adjacent battery cells 54 are made adjacent the top wall 68, and a venting arrangement is arranged adjacent bottom wall 70.

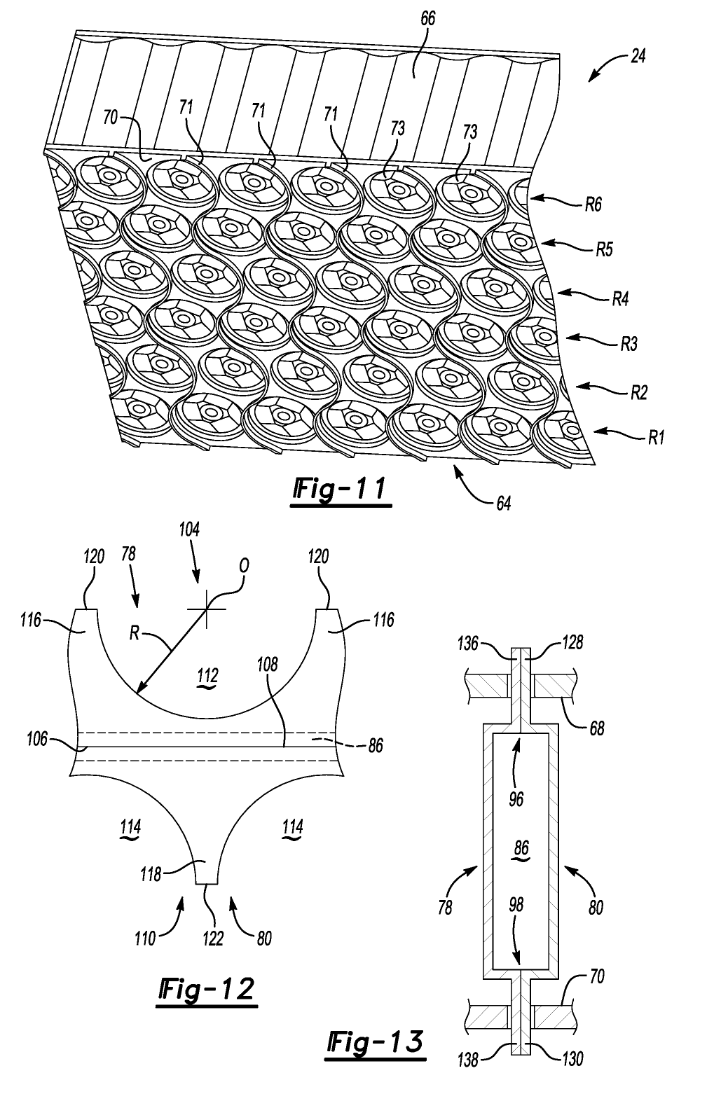

An example venting arrangement is shown in FIG. 11. In this example, ribs 71 extend between first and second side walls 64, 66. Ribs 71 are generally sinusoidal in this example and extend from bottom wall 70 to another wall structure. Bottom wall 70 includes openings 73 vertically beneath each of the cells 54. In a venting event, adjacent ribs 71 contain vented byproduct and direct the vented byproduct toward one of the first and second side walls 64, 66, as opposed to along the rows R1-R6, where the vented byproduct is released from the battery pack 24. This configuration limits interaction between vented byproduct and the battery cells.

With reference back to FIGS. 2-5, the battery pack 24 includes a plurality of fluid conduits 72A-72G, each of which is configured to direct thermal exchange fluid, such as coolant, water, etc., therein to transfer thermal energy between the thermal exchange fluid and the battery cells 54. In a particular example, the thermal exchange fluid is configured to absorb heat from the battery cells 54. Each of the fluid conduits 72A-72G individually, or a group of some or all of the fluid conduits 72A-72G collectively, may be referred to as a cooling jacket.

In an alternative configuration, each fluid conduit 72A-72G may include one or more features that remove the need for a separate bottom wall 70. As shown in FIG. 14 relative to fluid conduit 72B, each fluid conduit 72A-72G may include a plurality of standoffs 150, which are configured to support a battery cell 54 from below, together with a standoff of an adjacent fluid conduit. Further, the fluid conduits 72A-72G may each include the ribs 71 below standoffs 150, which function similar to ribs 71 of FIG. 11, with the exception that ribs 71 direct vented byproduct in a direction parallel to the length of the fluid conduits 72A-72G. Standoffs 150 and ribs 71, being incorporated into fluid conduits 72A-72G, may eliminate the need for bottom wall 70.

The fluid conduits 72A-72G are arranged relative to manifold assemblies 74, 76 to facilitate a flow of thermal exchange fluid relative to the fluid conduits 72A-72G. With reference to manifold assembly 74, each manifold assembly 74, 76 includes an inlet 75 and a plenum 77 between inlet 75 and end wall 60. End wall 60 includes a plurality of slots configured to direct thermal exchange fluid from plenum 77 into fluid conduits 72A-72G or receive fluid expelled from fluid conduits 72A-72G. While two manifold assemblies 74, 76 are shown in FIGS. 3 and 4, this disclosure extends to examples with one or more manifold assemblies. The manifold assembly or assemblies may enable flow of thermal exchange fluid within the fluid conduits 72A-72G in series or in parallel, as examples.

The manifold assemblies 74, 76 and fluid conduits 72A-72G enable transfer of thermal energy between the thermal exchange fluid and the battery cells 54 without directly bringing the thermal exchange fluid into contact with the battery cells 54. In this regard, the manifold assemblies 74, 76 and fluid conduits 72A-72G may be considered hermetically sealed.

The fluid conduits 72A-72G are made of polymer, and in a particular example are made entirely of polymer. The fluid conduits 72A-72G can therefore be relatively easily manufactured using known techniques, such as injection molding. The fluid conduits 72A-72G exhibit relatively high strength and heat transfer properties. The fluid conduits 72A-72G are also relatively light weight.

An example fluid conduit 72B is illustrated in FIG. 6. While fluid conduit 72B is shown, it should be understood that fluid conduit 72B is representative of each of the fluid conduits 72A-72G. The fluid conduits 72A and 72G, in an example, are configured to provide the side walls 64, 66, as will be discussed below.

The fluid conduit 72B is arranged between row R1 and row R2. Fluid conduit 72B is configured to facilitate relatively tight packaging between the battery cells 54 of rows R1 and R2 while directing thermal exchange fluid relative to the battery cells 54 and providing structural support to the battery pack 24.

In this example, fluid conduit 72B includes a first conduit section 78 and a second conduit section 80. The first and second conduit sections 78, 80 extend the entire distance between a first end 82 of the fluid conduit 72B and a second end 84 of the fluid conduit 72B opposite the first end 82. In this example, the first and second ends 82, 84 are configured to sealingly engage with the end walls 60, 62, respectively, to facilitate a fluid-tight connection with manifold assemblies 74, 76. The fluid conduit 72B includes a passageway 86 within which thermal exchange fluid can flow between the first and second ends 82, 84. The fluid conduit 72B is open adjacent first and second ends 82, 84, at which points thermal exchange fluid can enter or exit the passageway 86. A width dimension of the passageway 86 may vary along a length thereof. The passageway 86 may be substantially rectangular in cross-section.

With reference to FIGS. 6 and 12, the first conduit section 78 includes a first side 104 facing the row R1, and a second side 106 facing the second conduit section 80 and at least partially defining the passageway 86. The second conduit section 80 includes a first side 108 facing the first conduit section 78 and at least partially defining the passageway 86, and a second side 110 facing the row R2.

The first side 104 of the first conduit section 78 exhibits a plurality of cavities 112, and the second side 110 of the second conduit section 80 exhibits a plurality of cavities 114. Each cavity 112 is configured to receive a portion of one of the battery cells 54 of row R1, and each cavity 114 is configured to receive a portion of one of the battery cells 54 of row R2. Each cavity 112, 114 is substantially arcuate and exhibits a shape conforming to an exterior of the battery cells 54.

In an example, first side 104 directly contacts battery cells 54 of row R1, and second side 110 directly contacts battery cells 54 of the second group R2. In another example, a layer of adhesive and/or a layer of thermal interface material (TIM), some layers 148 of which are shown in FIG. 3, is arranged between the respective battery cells 54 and the first and second sides 104, 110 such that the battery cells 54 contact the fluid conduit 7B indirectly via the adhesive/TIM. The adhesive and/or TIM may take up any gaps or space between fluid conduits 72A-72G and adjacent battery cells 54 that may be present as result of the tolerances associated with the manufacturing processes of the battery cells 54, for example.

Each cavity 112, 114 is substantially semi-circular when viewed from a perspective of the top wall 68, for example. In particular, each cavity 112, 114 exhibits an arc substantially equal to a half circle, defined by a constant radius R having origin O. Radius R follows the contour of the first side 104 and second side 110. Cavities 112 are concave from a perspective of the battery cells 54 of row R1, and cavities 114 are concave from a perspective of battery cells 54 of row R2. Fluid conduits 72A, 72G, which provide side walls 64, 66, respectively, may exhibit a first or second conduit section that lacks the cavities of the fluid conduit 72B, because the fluid conduits 72A, 72G each exhibit one side that does not face a row of battery cells 54.

Cavities 112 are arranged between adjacent projections 116 of the first conduit section 78, and cavities 114 are arranged between adjacent projections 118 of the second conduit section 80. The projections 116, 118 exhibit end walls 120, 122, respectively, laterally aligned (i.e., up and down, with reference to FIG. 12) with origins O. Projections 116 of the first conduit section 78 are aligned, relative to a length dimension of the fluid conduit 72B (i.e., left and right, with reference to FIG. 12), with an origin O of one of the cavities 114. Likewise, projections 118 of the second conduit section 80 are aligned, relative to a length dimension of the fluid conduit 72B, with an origin O of one of the cavities 112. Such staggering facilitates relatively tight packaging of the battery cells 54.

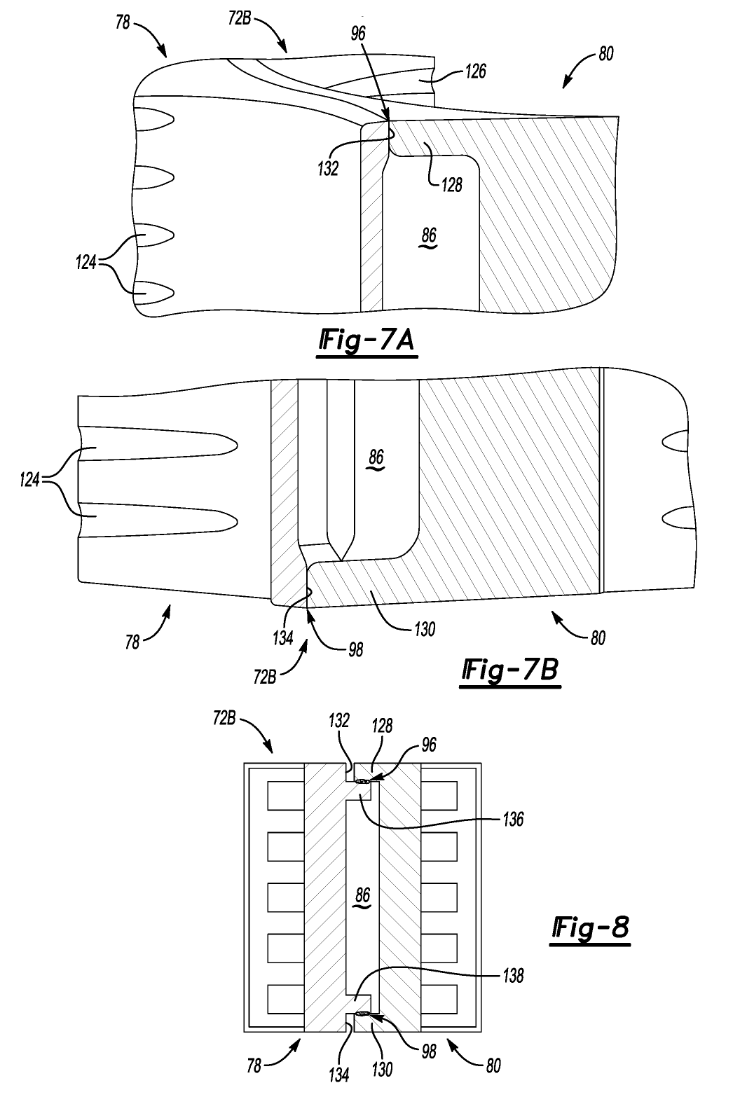

Projections 116, 118 each exhibit a plurality of spaced-apart recesses 124, 126 (FIGS. 6, 7A, and 7B), respectively, along a vertical dimension thereof. Recesses 124, 126 may be configured as notches or indentations. Recesses 124, 126 reduce the overall weight of the fluid conduit 72B without compromising strength. Recesses 124, 126 resist the formation of depressions in the surfaces of the first and second conduit sections 78, 80, as the respective sections cool following injection molding, for example. This disclosure is not limited to the height or spacing of the recesses 124, 126.

Each of the first conduit section 78 and the second conduit section 80 is formed entirely of polymer in this example. The first conduit section 78 and second conduit section 80 can each be separately formed by injection molding and then connected together in a fluid-tight manner, such as by welding and/or using adhesives. Forming the first and second conduit sections 78, 80 in such a manner permits the cavities 112, 114 to exhibit a minimal to no draft angle moving vertically within the cavities 112, 114, such that the cavities 112, 114 closely conform to the battery cells 54, which are cylindrical in one example, which leads to efficient thermal energy transfer.

With reference to FIGS. 6, 7A, and 7B, the passageway 86 is bound by a first sealed connection 96 (FIG. 7A) between the first conduit section 78 and the second conduit section 80, and a second sealed connection 98 (FIG. 7B) between the first conduit section 78 and the second conduit section 80. Sealed connections 96, 98 may be provided by welding, adhesive, and/or any other known technique for connecting polymer structures. Example welding techniques include laser welding, radio frequency (RF) welding, vibration welding, hot plate welding, hot gas welding, etc.

In the example of FIGS. 6, 7A, and 7B, the first and second sealed connections 96, 98, along with the second side 106 of first conduit section 78 and the first side 108 of second conduit section 80, fluidly bound a perimeter of the passageway 86.

With reference to FIGS. 7A and 7B, the second conduit section 80 includes a first projection 128 and a second projection 130 on an opposite side of the passageway 86 as the first projection 128. Further, the first conduit section 78 includes a first flat section 132 and a second flat section 134 on an opposite side of the passageway 86 as the first flat section 132. The first sealed connection 96 is provided between the first projection 128 and the first flat section 132, and the second sealed connection 98 is provided between the second projection 130 and the second flat section 134. The flat sections 132, 134 exhibit a substantially vertically (i.e., up-and-down, relative to FIGS. 7A-7B) flat face configured to abut a substantially vertically flat face of projections 128, 130. Alternatively, first conduit section 78 could include projections, and second conduit section 80 could include flat sections. The configuration of FIGS. 7A and 7B may facilitate a welded connection between the first and second conduit sections 78, 80.

FIG. 8 illustrates another interface between the first and second conduit sections 78, 80. In FIG. 10, projections 128, 130 are arranged in a vertically-overlapping manner with projections 136, 138 of the first conduit section 78, 80. Because projection 128 vertically overlaps projection 136 (when viewed from above), and projection 130 vertically overlaps projection 138 (when viewed from below), this arrangement facilitates welding the first and second conduit sections 78, 80 together. In particular, a laser welding technique may be used to establish sealed connections 96, 98.

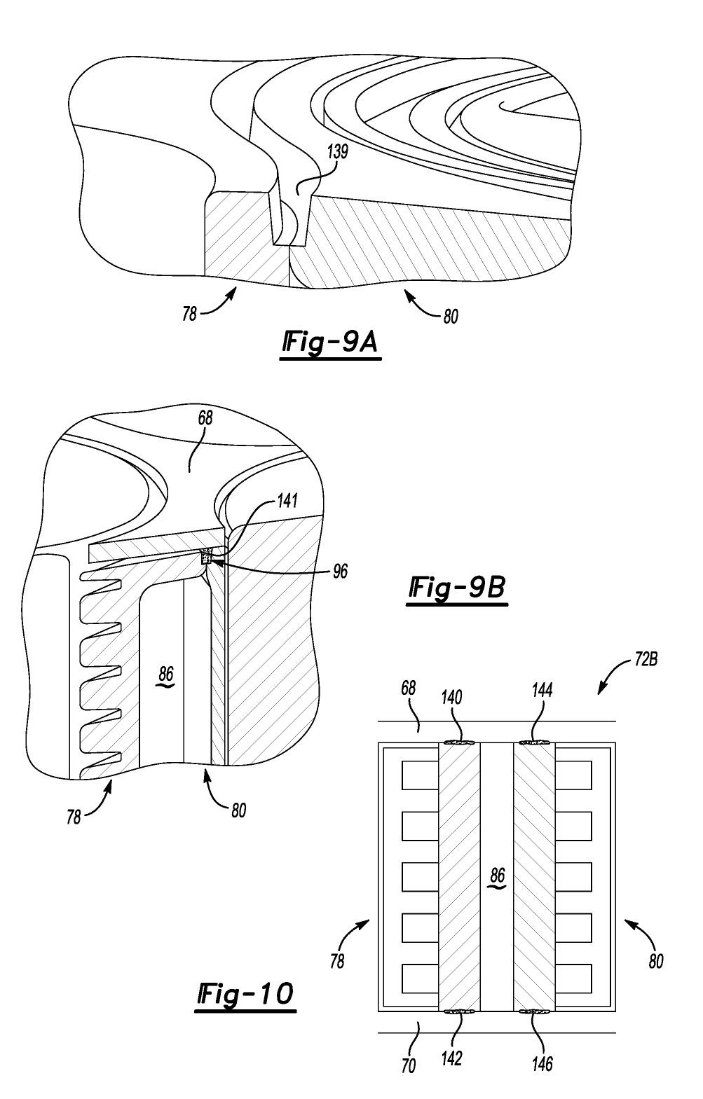

Another interface between the first and second conduit sections 78, 80 is shown in FIGS. 9A, 9B. In FIGS. 9A-9B, the first and second conduit sections 78, 80 each partially define a first groove 139 on a side thereof generally opposite the passageway 86. In this example, the first groove 139 faces top wall 68. The first groove 139 lies along an interface of the first and second conduit sections 78, 80. While not shown in FIGS. 9A-9B, a similar groove is provided adjacent a bottom of the passageway 86 to seal the passageway 86 from below. The first groove 139, and the second groove adjacent the bottom of the passageway 86, each extend the entire length of the fluid conduit 72B.

With continued reference to FIGS. 9A-9B, the first groove 139 receives a first insert 141, which is sized and shaped substantially similar to the first groove 139, and also extends along an entire length of the passageway 86. The first insert 141 is made of a polymer material in this example. The first insert 141 facilitates formation of sealed connection 96 via infrared welding, in an example. The infrared welding process fuses the first and second conduit sections 78, 80 and the first insert 141. Sealed connection 98 is also established via infrared welding in this example, with an insert similar to first insert 141 is received in second groove.

In another embodiment, shown in FIG. 10, the first and second conduit sections 78, 80 are connected in a fluid-tight manner to top wall 68 and bottom wall 70. In particular, in this example, a first sealed connection 140 is established between the first conduit section 78 and the top wall 68, a second sealed connection 142 is established between the first conduit section 78 and the bottom wall 70, a third sealed connection 144 is established between the second conduit section 80 and the top wall 68, and a fourth sealed connection 146 is established between the second conduit section 80 and bottom wall 70. The sealed connections 140, 142, 144, 146 may be provided by a welding technique, such as laser welding.

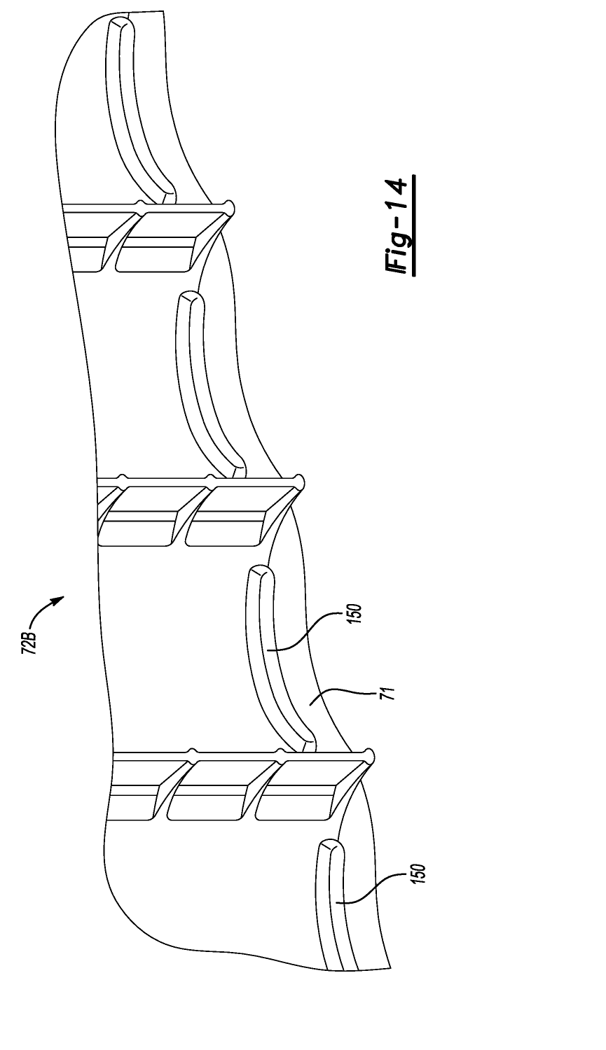

While in FIG. 8 projections 128, 130, 136, 138 were arranged in a vertically overlapping manner, projections 128, 130 could horizontally overlap one another, and projections 136, 138 could horizontally overlap one another, as in FIG. 13. The projections 128, 136 can be welded together to established the first sealed connection 96. Projections 130, 138 can likewise be welded together to establish the second sealed connection 98. Projections 128, 136 may partially project through top wall 68 and may be connected to top wall 68. Projections 130, 138 may partially project through bottom wall 70 and may be connected to bottom wall 70. In this embodiment, the first and second sections 78, 80 may be formed by thermoforming.

It should be understood that terms such as “about,” “substantially,” and “generally” are not intended to be boundaryless terms, and should be interpreted consistent with the way one skilled in the art would interpret those terms. Directional terms should be interpreted consistent with the context that those terms are used.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A traction battery pack, comprising:
a plurality of battery cells; and
a fluid conduit arranged adjacent the battery cells, wherein the fluid conduit defines a passageway configured to guide thermal exchange fluid relative to the battery cells, wherein the fluid conduit includes a first conduit section and a second conduit section, and wherein the first and second conduit sections are made of polymer.

2. The traction battery pack as recited in claim 1, wherein:
the fluid conduit section extends between a first end and a second end, and
the first and second conduit sections each extend from the first end to the second end.

3. The traction battery pack as recited in claim 1, wherein the first and second conduit sections are formed separately from one another.

4. The traction battery pack as recited in claim 3, further comprising:
a first sealed connection between the first and second conduit sections, and
a second sealed connection between the first and second conduit sections.

5. The traction battery pack as recited in claim 4, wherein the first and second sealed connections are configured such that the first and second conduit sections fluidly bound a perimeter of the passageway.

6. The traction battery pack as recited in claim 4, wherein the first and second sealed connections are provided by one or both of welding and adhesive.

7. The traction battery pack as recited in claim 6, wherein:
the first sealed connection is provided between a first projection and a first flat section, and
the second sealed connection is provided between a second projection and a second flat section.

8. The traction battery pack as recited in claim 6, wherein:
the first sealed connection is provided between a first projection and a second projection,
the first and second projections overlap one another,
the second sealed connection is provided between a third projection and a fourth projection, and
the third and fourth projections overlap one another.

9. The traction battery pack as recited in claim 8, wherein:
the first and second projections vertically overlap one another, and
the third and fourth projections vertically overlap one another.

10. The traction battery pack as recited in claim 8, wherein:
the first and second projections horizontally overlap one another, and
the third and fourth projections horizontally overlap one another.

11. The traction battery pack as recited in claim 6, wherein:
the first conduit section and the second conduit section each partially define a first groove,
the first conduit section and the second conduit section each partially define a second groove,
a first insert is arranged in the first groove,
a second insert is arranged in the second groove, and
the first sealed connection is established by a welding process that fuses the first conduit section, the second conduit section, and the first insert, and
the second sealed connection is established by a welding process that fuses the first conduit section, the second conduit section, and the second insert.

12. The traction battery pack as recited in claim 3, further comprising:
a top wall,
a bottom wall,
wherein a perimeter of the passageway is bound by the top wall, the first conduit section, the second conduit section, and the bottom wall.

13. The traction battery pack as recited in claim 12, further comprising:
a first sealed connection between the first conduit section and the top wall,
a second sealed connection between the first conduit section and the bottom wall,
a third sealed connection between the second conduit section and the top wall, and
a fourth sealed connection between the second conduit section and bottom wall.

14. The traction battery pack as recited in claim 1, wherein:
the plurality of battery cells includes a first group of battery cells and a second group of battery cells, and
the fluid conduit is arranged between the first and second groups of battery cells.

15. The traction battery pack as recited in claim 14, wherein:
a first side of the first conduit section faces the first group of battery cells, and a second side of the first conduit section faces the second conduit section and partially defines the passageway, and
a first side of the second conduit section faces the first conduit section and partially defines the passageway, and a second side of the second conduit section faces the second group of battery cells.

16. The traction battery pack as recited in claim 15, wherein:
the first side of the first conduit section directly contacts the first group of battery cells, and
the second side of the second conduit section directly contacts the second group of battery cells.

17. The traction battery pack as recited in claim 15, wherein:
the first side of the first conduit section contacts the first group of battery cells via a layer of thermal interface material, and
the second side of the second conduit section contacts the second group of battery cells via a layer of thermal interface material.

18. The traction battery pack as recited in claim 1, further comprising:
a manifold assembly configured to direct thermal exchange fluid to the passageway.

19. The traction battery pack as recited in claim 1, wherein the plurality of battery cells are cylindrical battery cells.

20. A method, comprising:
injection molding a first conduit section of a fluid conduit, wherein the fluid conduit is configured to define a passageway for thermal exchange fluid to flow within a traction battery pack;
injection molding a second conduit section of the fluid conduit; and
joining the first conduit section and the second conduit section so as to establish a fluid-tight seal between the first conduit section and the second conduit section.
